(19) United States
(12) Patent Application Publication
(10) Pub. No.: US 2002/0186115 A1
(43) Pub. Date: Dec. 12, 2002

(54) Metallic wire

(75) Inventor: Joachim Runge, Arolsen (DE)

Correspondence Address: SUGHRUE MION, PLLC, 2100 Pennsylvania Avenue, NW, Washington, DC, 20037-3213, US

(73) Assignee: NEXANS

(21) Appl. No.: 10/158,889

(22) Filed: Jun. 3, 2002

(30) Foreign Application Priority Data
Jun. 6, 2001 (DE) 10127556.0

(51) Int. Cl. H01F 27/28

(52) U.S. Cl. 336/222

(57) ABSTRACT

In a metallic wire for producing transformer windings, first segments (4a, 4b), in which the long axis of the cross section extends in a defined plane, alternate with second segments (4c), in which the long axis of the cross section extends perpendicular thereto.

This application is based on and claims priority from German Patent Application No. 10127556.0 filed Jun. 6, 2001, which is incorporated by reference herein.

### BACKGROUND OF THE INVENTION

The invention relates to a metallic wire in accordance with the preamble of claim 1 and to a winding for transformers in accordance with the preamble of claim 3.

In windings for oil-cooled transformers, paper-insulated wires or transposed conductors having a constant thickness/width ratio over their entire length are used. The wires are wound onto a magnetizable metal core.

Such an arrangement of the metal wires does not take into account the different field strengths in the center and at the ends.

As a consequence, the losses in the transformer are increased and the efficiency is reduced.

### SUMMARY OF THE INVENTION

An object of the present invention is thus to provide a metal wire for transformer windings that obviates the described drawbacks, or to provide a winding that makes it possible to reduce the stray-field losses in a transformer and to improve the transformer's efficiency.

This object is attained by the features set forth in claims 1 and 3.

Advantageous further embodiments are set forth in the dependent claims.

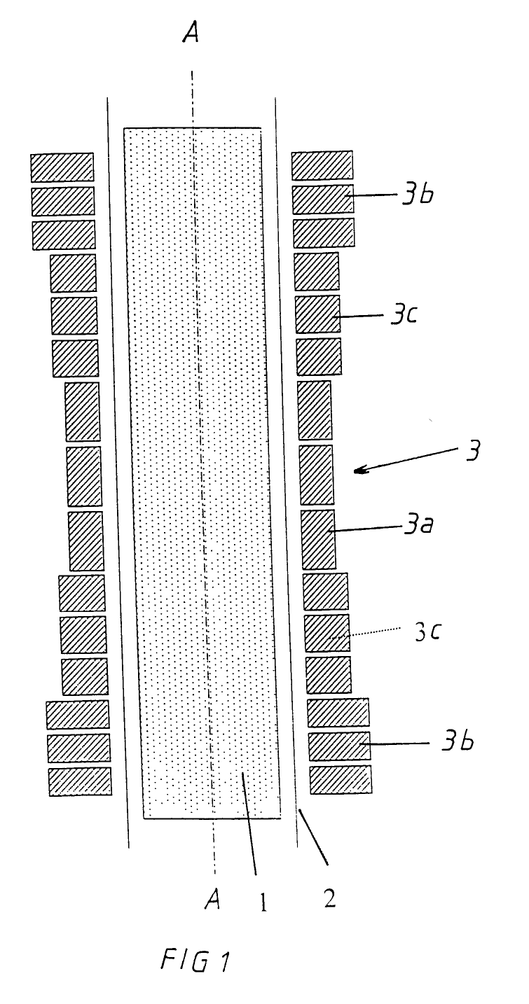

FIG. 1 depicts a winding; and

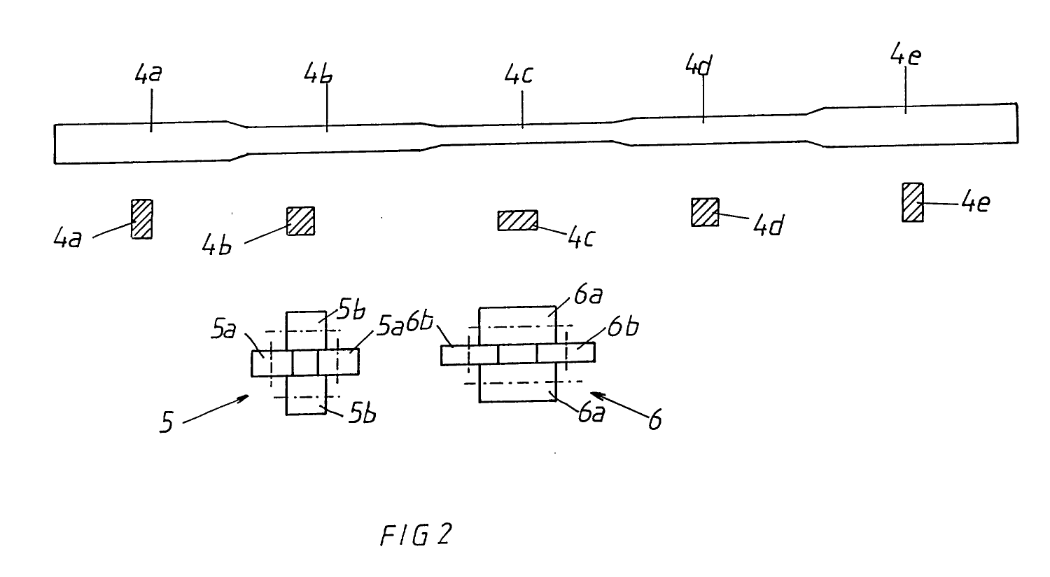

FIG. 2, illustrates a prooduction process according to the invention, with the upper half of FIG. 2 showing a side elevation of a metallic wire and the lower half of FIG. 2 showing the rolling machines.

### DETAILED DESCRIPTION OF THE INVENTION

FIG. 1 depicts a winding, e.g., for a transformer, which comprises an iron core 1 and a cylinder 2, e.g., made of paperboard or insulating board, which is arranged over the iron core. Iron core 1 and cylinder 2 are located in the interior of a wire winding 3. The wire winding 3 consists of a length of copper profile with a rectangular cross section. According to the teaching of the invention, this copper profile is wound such that in the center area 3a of winding 3 the long axis of the copper profile extends parallel to the center axis A of the winding. In contrast, in the end areas 3b of winding 3, the long axis of the copper profile extends perpendicular to the center axis A of winding 3. Between the areas 3a and 3b, i.e., at 3c, the copper profile 3 has a nearly square cross section.

By changing the cross section of the copper profile over the course of winding 3, the stray-field losses can be reduced and the efficiency of a transformer equipped with an inventive winding 3 can be increased.

The copper profile can be a solid flat copper wire. It is also possible, however, to use a profile comprising a plurality of conductor elements arranged one on top of the other, e.g., a so-called transposed conductor, which can be produced by Roebel transposition of flat conductor elements.

An exemplary embodiment of a production process will now be described in greater detail with reference to FIG. 2.

The upper half of FIG. 2 shows a side elevation of a metallic wire 4 according to the teaching of the invention. This wire comprises a total of five segments 4a, 4b, 4c, 4d and 4e.

As shown in the section views, segments 4a and 4e have a flat profile with a long axis perpendicular to the horizontal, and segments 4b and 4d have a nearly square cross section. The center segment 4c is rotated by 90° relative to segments 4a and 4e.

Such a metallic wire 4 can be produced, for instance, by metallurgical joining techniques, e.g., by welding or soldering the individual segments 4a to 4e. The junctions between the segments 4a to 4e must be correspondingly adapted to each other, i.e., the cross section of the metal wire 4 must have the same size across the entire length.

Another method for producing the metal wire 4 is to shape the individual segments 4b, 4c and 4d by means of a sizing press or section rolling.

The lower half of FIG. 2 depicts the section rolling machines that are being used.

Section rolling machines 5 and 6 have two roll pairs each, 5a and 5b and 6a and 6b. The roll pairs 5a and 5b as well as 6a and 6b can advantageously be driven. They are furthermore adjustable in the direction of the roll nip.

The process sequence is as follows:

Segment 4e passes freely through the section rolling machines 5 and 6. When segment 4d reaches the first section rolling machine 5, the roll pairs 5a and 5b are adjusted such that a nearly square cross section results. Segment 4d with the square cross section passes freely through the section rolling machine 6.

Segment 4e, like segment 4d, is first shaped into a square cross section. When the shaped segment 4c reaches the second section rolling machine 6, the roll pairs 6a and 6b are adjusted as shown below and the square profile is shaped into a flat rectangular profile.

Segment 4b is shaped into a square by the rolling machine 5 and passes freely through rolling machine 6. Segment 4a, like segment 4e, is not being shaped and passes freely through the section rolling machines 5 and 6 in which the roll pairs 5a and 5b as well as 6a and 6b have been driven apart.

A metallic wire of great length can thus be produced. The wire segments required to produce the windings can then be cut from these wire lengths.

What is claimed is:

1. A metallic wire, preferably made of copper, with a flattened rectangular cross section for producing transformer windings, characterized in that first segments (4a, 4b), in which the long axis of the cross section extends in a defined plane, alternate with second segments (4c), in which the long axis of the cross section extends perpendicular thereto.

2. A metallic wire as claimed in claim 1, characterized in that segments (4b, 4d) with a nearly square cross section are located between the first segments (4a, 4e) and the second segments (4c).

3. A winding for a transformer with a metallic wire as claimed in claim 1, in which the wire is wound onto a magnetic core, characterized in that in the center area (3a) of the magnetic core (1) the long axis of the cross section of the metal wire extends parallel to the longitudinal axis of the magnetic core (1) and in the area at the end (3b) of the magnetic core (1) the long axis of the cross section of the metal wire extends perpendicularly to the longitudinal axis of the magnetic core (1).

4. A winding as claimed in claim 3, characterized in that the metal wire has a nearly square cross section between the center area (3a) and the areas (3b) at the end of the magnetic core.
